(19) United States
(12) Patent Application Publication
(10) Pub. No.: US 2025/0367875 A1
(43) Pub. Date: Dec. 4, 2025

(54) METHOD FOR COUNTERACTING SHRINKAGE OF EXTRUDED MATERIALS

(71) Applicants: Christoph Klemmt, Cincinnati, OH (US); Gregory Beaucage, Cincinnati, OH (US)

(72) Inventors: Christoph Klemmt, Cincinnati, OH (US); Gregory Beaucage, Cincinnati, OH (US)

(21) Appl. No.: 19/217,093

(22) Filed: May 23, 2025

Related U.S. Application Data
(60) Provisional application No. 63/655,627, filed on Jun. 4, 2024.

(51) Int. Cl. B29C 64/165; B29C 48/00; B29K 1/00; B29K 511/14; B33Y 10/00; B33Y 70/10

(52) U.S. Cl. CPC B29C 64/165; B29C 48/0012; B29K 2001/00; B29K 2511/14; B29K 2995/0097; B33Y 10/00; B33Y 70/10

(57) ABSTRACT

The present invention is for a method to cause an expansion of material extruded by an extruder after its discharge from the extruder and prior to the material's full solidification. The expansion is caused by springs incorporated into the extrusion slurry. The springs are compressed in the extruder due to its internal pressure and the shear stress. Once released from the extruder, the pressure is released, and the springs expand or straighten, thereby causing an expansion of the extrudate. This expansion can be used to counteract the shrinkage of the extrudate due to processes such as thermal contraction or solvent evaporation, or may be used to otherwise alter the shape of the extrudate after its extrusion.

### TECHNICAL FIELD

The present embodiments relate to manufacturing by means of material extrusion, including the extrusion-based three-dimensional printing, or 3D-printing. Specifically, a method is provided that causes an expansion of the extruded material after its extrusion, that can be used to counteract a shrinkage of the material after extrusion.

### BACKGROUND

A common method of manufacturing is the extrusion of viscous material, the slurry, while giving the material its desired shape, followed by a solidification of the material. A more specific method that utilizes this material extrusion is the extrusion-based 3D-printing. The viscous material is inserted into an extruder, which presses it out through a nozzle, with the necessary pressure created often by means of a rotating auger or hydraulic pressure. In 3D-printing, the extruder and nozzle are then moved while the material is extruded along a toolpath, controlled by a computer, to create the shape of the object that is manufactured. Alternatively, the extruder can remain in place while the 3D-printing base and the already extruded material are moved to create the designed object. The subsequent change from viscous to solid material can be caused by a change in temperature as in thermoplastic extrusion, a chemical curing, or the evaporation of a solvent.

A commonly observed behavior that can impact the precision of this manufacturing method is a change in volume of the extruded material after its release from the nozzle. This includes die-swell, an expansion of the material once the pressure of the extruder is released immediately after extrusion, as well as a shrinkage, and rarely expansion, of the material during the solidification process.

Especially in the 3D-printing of biodegradable materials, where the solidification is based on the evaporation of water, the shrinkage has been identified as a problem. However, also in other extrusion methods, the shrinkage during the material's solidification can cause not only a change in size of the manufactured object, but also deformations of its geometry. To avoid those problems, methods have been proposed to adjust the toolpath during the extrusion process to accommodate for the anticipated shrinkage and deformations.

### BRIEF SUMMARY

The present invention uses springs as part of a composite in the slurry that act to cause an expansion of the extruded material after its ejection from the nozzle. In the extruder, the springs are bent or compressed due to the pressure exerted on the material by the extruder and the shear stress. Upon the material's release from the nozzle, the extruder pressure and shear stress on the material ceases and the springs in the material relax and straighten or expand, thereby causing the extrudate to expand. The amount and speed of this spring-swell can be tuned, among other parameters, by the spring concentration, spring constant or modulus, spring dimensions, and the slurry viscosity and temperature. The present invention uses this behavior to cause an expansion of the extruded material. This expansion can be used to counteract shrinkage caused during the solidification of the extruded material. Upon the full solidification of the material, the springs cease to expand.

### BRIEF DESCRIPTION OF THE DRAWINGS

FIG. 1 is a possible setup to 3D-print material that utilizes the expansion behavior of the fibers. It consists of an extruder attached to a robotic arm.

FIG. 2 is a possible extruder to 3D-print material that utilizes the expansion behavior of the fibers.

FIG. 3 shows a cross section through the nozzle and slurry, diagrammatically showing the springs as leaf springs and their bending behavior at three different time stages.

FIG. 4 is a diagram that shows the samples, computationally extracted curves that are close to the individual fibers, and bounding boxes of those curves, for four different samples that vary in their slurry viscosity and accordingly the ability of the fibers to straighten.

FIG. 5 is a diagram that shows the initial expansion phase over time for the four samples of FIG. 3.

FIG. 6 is a diagram that shows the initial expansion phase and subsequent shrinkage phase over time for the four samples of FIG. 3.

FIG. 7 is a comparison of the design geometry, a 3D-print made with fibers that do not act as springs, and a 3D-print made with fibers that act as springs.

### DETAILED DESCRIPTION OF THE INVENTION

The shrinkage of extruded material during solidification after its discharge from the extruder's nozzle can cause a change in size as well as deformations of the extruded part. This is a problem for many extrusion and 3D-printing processes, including but not limited to those that are based on biodegradable slurries and use the evaporation of a solvent for solidification or in curing processes involving network formation.

In order to alleviate this problem, this invention causes an expansion of the slurry after leaving the extruder's nozzle prior or during its solidification process. This invention causes the expansion through the incorporation of springs in the extrusion slurry. The springs are compressed or bent under the pressure of the extruder and the shear stress, but expand, straighten, or otherwise relax once this pressure is released, causing a “spring-swell”.

“Material”, “extrusion material” or “extrudate” refers to the material that is extruded, in both its viscous and its solidified states. “Slurry” refers to the extrusion material in its viscous state before, during and after extrusion, but prior to its completed solidification. “Material”, “extrusion material”, “extrudate” and “slurry” can refer to any material for extrusion, including but not limited to reactive or reversibly reactive polymer melts, natural or synthetic clay, soil, aqueous suspension, fungus, bacteria, living matter, cementitious materials, tar, uncured or cured rubber, metals, food, or composites of these materials.

“Extruder”, beyond its standard definition, refers to any device that ejects the extrusion slurry, often but not necessarily through a nozzle.

“Solidification” refers to the process of reduction of the extruded material's viscosity after extrusion, which can be caused by processes including but not limited to a change in temperature as in thermoplastic extrusion, a chemical curing, chemical crosslinking, reactive or reversibly reactive processes, or the evaporation of a solvent as in clay or cellulosic extrusion.

“Spring” refers to a device usually made from an elastic material that exhibits resilient characteristics when distorted or deflected and that can return fully or partly to its original or near-original shape after being distorted or deflected. A spring can be of molecular scale with a median length below 0.000001 mm, colloidal scale with a median length between 0.000001 mm and 0.1 mm, or macroscopic scale with a median length above 0.1 mm. “Compression” refers to the distortion or deflection of a spring, including but not limited to its compression, bending, or otherwise distortion from its original relaxed shape. “Relaxation” and “expansion” of a spring refers to the spring's full or part return to its original or near-original shape after being compressed, including the relaxation of a spring that straightens or relaxes in different ways rather than expand along one or more directions.

In some embodiments of the invention, the springs are leaf springs. The leaf springs are compressed by bending under the pressure of the extruder, and relax by straightening upon their discharge from the nozzle.

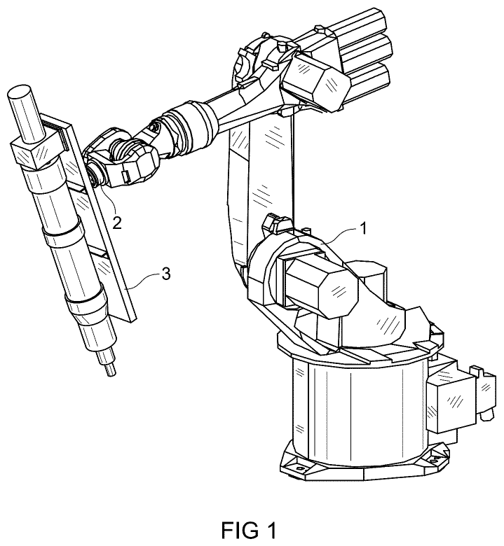

A possible setup for the 3D-printing of a slurry with springs at a larger scale is shown in FIG. 1. It uses a computer-controlled robotic arm 1 (KUKA KR20-3 with controller KR C4) for the motion control of the toolpath. A tool changer 2 (Millibar MTC-UR3510) is connected to the robotic arm, which in turn holds the extruder 3.

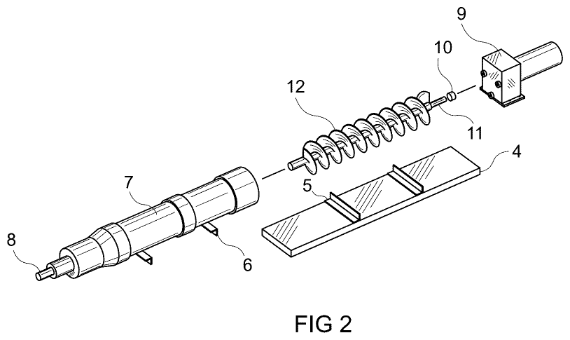

FIG. 2 shows a possible design for the extruder 3. The tool changer 2 is connected to the frame 4 (Aluminum RHS, 125 mm×50 mm×3 mm) of the extruder. Brackets 5 and 6 (Aluminum Angles, 40 mm×40 mm×3 mm) are connecting the frame to PVC pipes 7 (PVC pipes: 100 mm×100 mm×50 mm Wye, 100 mm×300 mm clear pipe, 100 mm×50 mm reducer hub, 50 mm×100 mm pipe, 50 mm×40 mm/25 mm reducer hub) that have been glued together and include openings at the top, the bottom and the side. PVC nozzles with different diameters 8 (40 mm/25 mm/19 mm diameter) can be screwed onto the end of the PVC pipes. A motor 9 (Dayton Model 1Z824 DC Gear Motor 50 RPM ⅙ hp 12VDC) is attached to the frame. It rotates an auger 12 with decreasing diameters (100 mm diameter, 50 mm diameter, 20 mm diameter) to which it is connected via a coupling 10 (Lovejoy L099 HUB, keyed flexible shaft coupling 16 mm/19 mm) and a steel rod connector 11.

During the extrusion process, the material is fed into the PVC pipes 7 through the opening on the side. When the motor 9 is turned on, it rotates the auger 12, thereby pressing any material in the main PVC pipe downwards and out of the nozzle 8. The robotic arm 1 moves the extruder during the 3D-printing process, thereby controlling the location of the material deposition over time, and in turn the resulting shape of the extruded material.

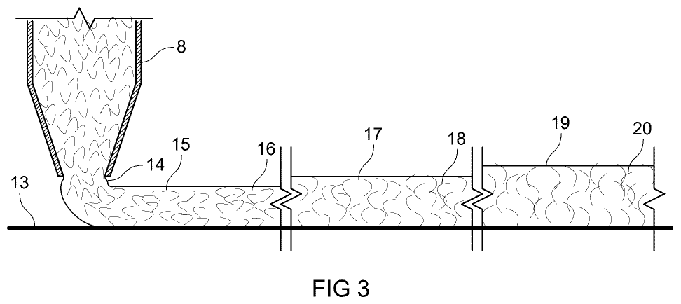

FIG. 3 shows a cross section through the nozzle 8 and a slurry containing leaf springs, with the spring-swell of this slurry occurring at a slower rate than its dye-swell. The material is extruded onto the base 13 and shown at three different time stages from left to right. Depending on the material, a die-swell likely causes it to expand directly outside of the nozzle in the zone 14. The spring-swell can occur at a much slower speed than the die-swell. Therefore, for this slurry, soon after the extrusion, the material 15 has a volume only slightly expanded after the die-swell. At this point, the leaf springs 16 in the slurry 15 are mostly still bent from the pressure of the extruder. The leaf springs will also likely show an alignment with the bead direction caused by shear thinning. At a later stage, the leaf springs 18 will have started to straighten, due to their alignment mostly orthogonal to the bead direction. This will start to cause an expansion orthogonal to the bead direction of the extruded material 17. At an even later stage, the leaf springs 20 have mostly straightened and caused an even greater expansion of the material 19.

Depending on the speed of the material's spring-swell in relation to the speed of the material's solidification, the springs can mostly or fully relax while the slurry has not yet fully solidified, or the solidification can terminate the springs' ability to fully relax.

The expansion behavior can be tuned, amongst other parameters, by the concentration of springs in the slurry, their dimensions, their material, their modulus, the viscosity of the slurry, its temperature, the solidification time of the slurry, the pressure of the extruder, and the alignment of the springs with the bead direction caused by the extruder.

In some embodiments of this invention, the springs are made from metal.

In some embodiments of this invention, the springs are made from plastic.

In some embodiments of this invention, the springs are made from plant fiber.

In some embodiments of this invention, the springs are made from wood.

In the preferred embodiments of this invention, the springs are made from wood fibers and have a median length of 1 mm-50 mm, a median width of 0.1 mm-20 mm, and a median thickness of 0.01 mm-2 mm. In the preferred embodiment of this invention, the slurry consists of, by weight, 4 parts wood fibers that act as springs, 2 parts methylcellulose with a viscosity of around 4000 cps at 2% solution, 2 parts hydroxypropyl methylcellulose with a viscosity of around 15 cps at 2% solution, and 24 parts water. In the preferred embodiment of this invention, the slurry is extruded at a nozzle diameter of 19 mm and a layer height of 8 mm. At room temperature, the spring-swell of this material causes an expansion over a few hours, while the material continues to shrink afterwards for several days until it is fully solidified.

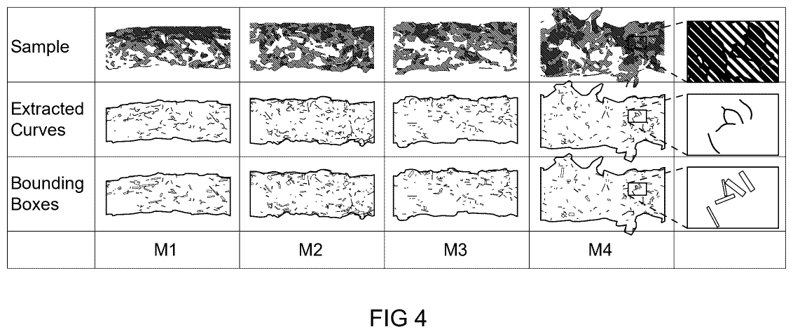

FIG. 4-FIG. 6 show a comparison of 4 different slurry compositions that are based on the slurry of the preferred embodiment of this invention. The compositions vary in the viscosity of their binder, by blending the high viscosity methylcellulose with a viscosity around 4000 cps at 2% solution with the low viscosity hydroxypropyl methylcellulose with a viscosity of around 15 cps at 2% solution. Within the 4 parts by weight of binders of the slurry composition of the preferred embodiment of this invention, the composition labelled M1 uses all of those 4 parts as said methylcellulose, M2 uses 3 parts of said methylcellulose and 1 part of said hydroxypropyl methylcellulose, M3 uses 2 parts of said methylcellulose and 2 parts of said hydroxypropyl methylcellulose, thereby constituting the exact slurry composition of the preferred embodiment of this invention, and M4 uses 1 part of said methylcellulose and 3 parts of said hydroxypropyl methylcellulose.

FIG. 4 shows a comparison of the bending of the wood springs in the final solidified samples of straight extruded beads of the four compositions M1-M4. The top row of FIG. 4 shows drawings of the samples, the middle row shows curves computationally extracted from photographs of the samples, and the bottom row shows bounding boxes of those curves. As the binder viscosity decreases from M1-M4, it becomes easier for the springs to relax, and the outline of the samples increase in diameter. The curve analysis shows how the decrease of the viscosity results in straighter springs.

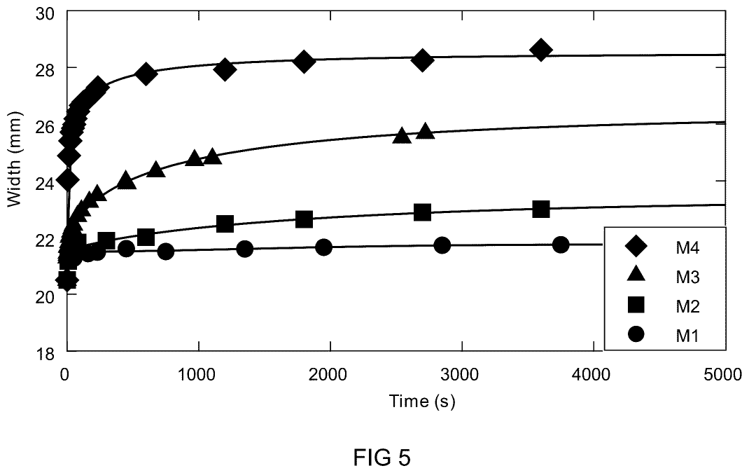

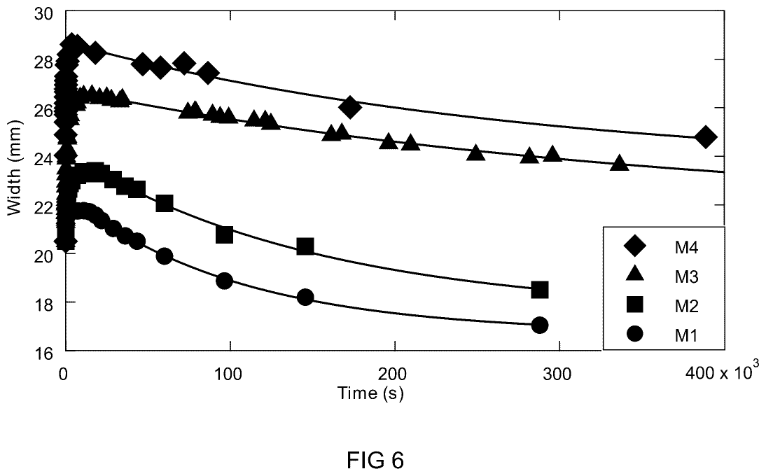

FIG. 5 and FIG. 6 show the bead diameter for the four slurry compositions M1-M4 over time. FIG. 5 shows the bead diameters in the first 5000 seconds, which covers the expansion phase of the slurries. FIG. 6 shows the development up to 400,000 seconds, which includes the shrinkage phase of the material during its solidification. The lower binder viscosity results in a larger expansion of the extrudate even after its shrinkage.

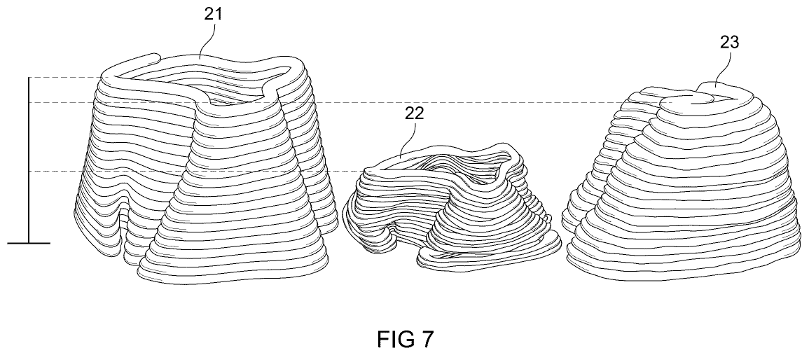

FIG. 7 shows a comparison of the newly extruded slurry of a design 21, the resulting solidified geometry of the slurry composition of the preferred embodiment of this invention with the parts of the wood springs replaced with the same weight of paper pulp cellulose fibers 22, and a similar solidified geometry of the slurry composition of the preferred embodiment of this invention 23. All three geometries 21-23 consist of 19 layers with 8 mm layer height at extrusion. The cellulose fibers do not cause the spring-swell in this slurry composition and show the difference that can be achieved by the spring-swell. The solidified 3D-print with the cellulose fibers 22 shows significant shrinkage, deformations, warping, as well as layer delamination. The 3D-print with the expanding wood fibers 23 still shows some shrinkage compared to the newly extruded slurry 21, but only minor deformations and no layer delamination.

The lower binder viscosity and larger expansion result in a lower density of the material and in a weaker physical performance. As the physical performance as well as the manufacturing parameters play a role in formulating a suitable material composition, a slurry may be designed with an expansion to reduce its shrinkage rather than to completely eliminate it. The slurry composition of the preferred embodiment of this invention does this. As shown in FIG. 7, 3D-print 23, it still allows some shrinkage, but performs well during extrusion and physical load testing of the resulting pieces.

The spring-swell can be used as a parameter in multi-material extrusion, or in functionally graded materials. In those methods, materials or material properties are differentiated across the final product. If the spring-swell is used as a parameter in multi-material extrusion or in functional grading, the final piece can have differences of expansion across its volume.

A use of the spring-swell in multi-material extrusion or in functional grading can be used to cause intentional and defined deformations of the extrudate during the spring swell and solidification that lead to the final geometry of the extruded piece.

What is claimed is:

1. A method for causing an expansion of material extruded from an extruder, with the expansion caused by springs that are incorporated into the material, whereby the springs are compressed inside of the extruder due to its internal pressure, but relax when this pressure is released after the material's discharge from the extruder.

2. The method of claim 1, whereby the median length of the springs is at least 0.1 mm.

3. The method of claim 1, whereby the springs are leaf springs.

4. The method of claim 1, whereby the springs are leaf springs made from wood with a median length of 1 mm-50 mm, a median width of 0.1 mm-20 mm, and a median thickness of 0.01 mm-2 mm.

5. A method for causing an expansion of material extruded from an extruder, the method being used at least in part to reduce or eliminate the shrinkage of the material that occurs during its solidification process after its extrusion, with the expansion caused by springs that are incorporated into the material, whereby the springs are compressed inside of the extruder due to its internal pressure, but relax when this pressure is released after the material's discharge from the extruder.

6. The method of claim 5, whereby the median length of the springs is at least 0.000001 mm.

7. The method of claim 5, whereby the median length of the springs is at least 0.1 mm.

8. The method of claim 5, whereby the springs are leaf springs.

9. The method of claim 5, whereby the springs are leaf springs with a median length of at least 0.1 mm.

10. The method of claim 5, whereby the springs are leaf springs with a median length of 1 mm-50 mm, a median width of 0.1 mm-20 mm, and a median thickness of 0.01 mm-2 mm.

11. The method of claim 5, whereby the springs are leaf springs with a median length of at least 0.1 mm made from plant material.

12. The method of claim 5, whereby the springs are leaf springs made from wood with a median length of 1 mm-50 mm, a median width of 0.1 mm-20 mm, and a median thickness of 0.01 mm-2 mm.

13. A method for causing an expansion of material extruded from an extruder, the method being used at least in part to influence the geometry or internal structure of the final solidified extruded piece, with the expansion caused by springs that are incorporated into the material, whereby the springs are compressed inside of the extruder due to its internal pressure, but relax when this pressure is released after the material's discharge from the extruder.

14. The method of claim 13, whereby the median length of the springs is at least 0.000001 mm.

15. The method of claim 13, whereby the median length of the springs is at least 0.1 mm.

16. The method of claim 13, whereby the springs are leaf springs.

17. The method of claim 13, whereby the springs are leaf springs with a median length of at least 0.1 mm.

18. The method of claim 13, whereby the springs are leaf springs with a median length of 1 mm-50 mm, a median width of 0.1 mm-20 mm, and a median thickness of 0.01 mm-2 mm.

19. The method of claim 13, whereby the springs are leaf springs with a median length of at least 0.1 mm made from plant material.

20. The method of claim 13, whereby the springs are leaf springs made from wood with a median length of 1 mm-50 mm, a median width of 0.1 mm-20 mm, and a median thickness of 0.01 mm-2 mm.
